(19) United States
(12) Patent Application Publication
(10) Pub. No.: US 2025/0136278 A1
(43) Pub. Date: May 1, 2025

(54) METHOD AND SYSTEM FOR SURVEILLANCE OF A PASSENGER CABIN OF AN AIRCRAFT

(71) Applicant: Airbus Operations GmbH, HAMBURG (DE)

(72) Inventor: Frederik SOBECK, HAMBURG (DE)

(21) Appl. No.: 18/924,648

(22) Filed: Oct. 23, 2024

(30) Foreign Application Priority Data
Oct. 26, 2023 (EP) 23205960.0

(51) Int. Cl. B64D 11/00; G06V 10/70; G06V 20/20; G06V 20/40; G06V 20/59; H04N 7/18

(52) U.S. Cl. CPC B64D 11/0015; G06V 20/20; G06V 20/41; G06V 20/593; H04N 7/181; G06V 10/70

(57) ABSTRACT

A method for surveillance of a passenger cabin of an aircraft comprises capturing a live video feed of the passenger cabin with a video surveillance system; collecting seat belt condition data of passenger seats within the passenger cabin with a seat belt sensor system; assessing with a computer-based evaluation system a current seat occupation status of the passenger seats based on the captured live video feed and a current seat belt status of the passenger seats based on the collected seat belt condition data; wirelessly transmitting the seat occupation status and the seat belt status to a portable crew device, the portable crew device being a pair of smart glasses; and projecting visual cabin information representing the seat occupation status and the seat belt status on the portable crew device.

### CROSS-REFERENCES TO RELATED APPLICATIONS

This application claims the benefit of European Patent Application Number 23205960.0 filed on Oct. 26, 2023, the entire disclosure of which is incorporated herein by way of reference.

### FIELD OF THE INVENTION

The present invention pertains to a method and system for surveillance of a passenger cabin of an aircraft.

### BACKGROUND OF THE INVENTION

As per certification specifications, it may be required for a cabin attendant to have visual sight of the aisle of an aircraft and also sight of at least 50% of the passengers. This may in particular apply to critical phases of a flight, including take-off and landing. During these critical phases, the cabin attendants usually have to remain at respective flight attendant seats while being capable of monitoring the passenger seats in accordance with the above-cited regulation requirements. Due to these requirements the crew attendant seats may have to be located appropriately within the cabin and to be oriented toward certain cabin areas that are to be monitored.

To enable the cabin attendant to be seated against flight direction for better space usage in the rear end of the aircraft opposite of the galleys, a monitoring system using a camera for passenger and aisle surveillance may be used. The camera view may then displayed on a monitor at the galley end of the cabin opposite to the flight attendant. See, for example, document EP 3 606 818 B1 for an example of such a cabin monitoring system.

Document EP 2 939 924 A1 describes the use of a wearable device as digital crew assist that is connectable with one or more aircraft related systems such as a cabin management system as well as sensors, actuators and so on.

Document EP 2 819 100 A1 describes the use of augmented reality images in an aircraft during flight to enhance the well-being of passengers and to display technical aspects of the aircraft on a portable device of the passengers.

### SUMMARY OF THE INVENTION

Against this background, it is an object of the present invention to find a solution for cabin surveillance with less complexity and with reduced costs.

This object may be achieved by a method having the features of one or more embodiments described herein and an aircraft according to one or more embodiments.

According to the invention, a method for surveillance of a passenger cabin of an aircraft comprises capturing a live video feed of the passenger cabin with a video surveillance system; collecting seat belt condition data of passenger seats within the passenger cabin with a seat belt sensor system; assessing with a computer-based evaluation system a current seat occupation status of the passenger seats based on the captured live video feed and a current seat belt status of the passenger seats based on the collected seat belt condition data; wirelessly transmitting the seat occupation status and the seat belt status to a portable crew device, the portable crew device being a pair of smart glasses; and projecting visual cabin information representing the seat occupation status and the seat belt status on the portable crew device.

Further according to the invention, an aircraft has a passenger cabin comprising a plurality of passenger seats and a cabin surveillance system, wherein the cabin surveillance system comprises a video surveillance system configured to capture a live video feed of the passenger cabin; a seat belt sensor system configured to collect seat belt condition data of passenger seats within the passenger cabin; a computer-based evaluation system configured to assess a current seat occupation status of the passenger seats based on the captured live video feed and a current seat belt status of the passenger seats based on the collected seat belt condition data and to wirelessly transmit the seat occupation status and the seat belt status; and a portable crew device, the portable crew device being a pair of smart glasses and being configured to receive the seat occupation status and the seat belt status from the computer-based evaluation system and to project visual cabin information representing the seat occupation status and the seat belt status on the portable crew device.

Thus, one idea of the present invention is to digitalize the cabin environment and automatize surveillance of it by providing the cabin crew with information on seat occupation and seatbelt statuses continuously and automatically on their smart glasses. The use of wireless information transfer technology facilitates oversight of the relevant situation without restricting the cabin attendants to a specific location in the aircraft, as they have all information in sight at any position and viewing direction. In consequence, cabin operations such a checking for fastened seatbelts and fulfilling certification requirements such as visual coverage of the passengers and/or the aisle can be done much more flexible and efficient. Also movement of the cabin crew can be reduced, which in turn enhances safety, especially during turbulences and other difficult situations, as the crew can remain seated while still having full overview of the situation due to the projected information on their glasses. With the use of smart glasses weight can be reduced, as heavy monitors and the necessary electrical and mechanical installations are no longer required.

Such a digitalized cabin may comprise cameras and other detection devices as part of the video surveillance system. The computer-based evaluation system may then recognize whether seats are empty or occupied based on object/pattern recognition algorithms, which may, for example, utilize advanced machine learning and/or artificial intelligence based evaluation. Such systems may also be used to assess various others aspects and/or data on the current cabin situation, e.g. whether passengers are seated or standing, or indications of an emergency or other situation requiring the immediate attention of the cabin crew. The evaluation system may be provided as a dedicated computer system (cabin monitoring computer) or may be part of such a system, which may be integrated or communicatively coupled to a cabin management system of the respective aircraft.

Furthermore, seatbelts may be provided with suitable sensors to assess whether they are (properly) closed and/or open. Such sensor may comprise, for example, wired contact switches on the seat belts. In another example, the seat belts may be equipped with near field communication (NFC) technology that can determine their closing status.

The evaluation of both information, that is, the seat occupation status and the seat belt status, allows for a detailed assessment of each seat inside the cabin as to its status. The system can thus automatically analyze whether seats are occupied or not and whether the respective seatbelts are fastened or not.

Sharing of this information via a wireless data network to the crew's smart glasses, provides them with the ability to check the current status of the cabin in real-time, in principle even without having direct sight of it. A full or partial view of the cabin may be projected on their glasses and additional information about the cabin may be overlayed. For example, dedicated indicators, icons, scales or other graphical elements may be projected and/or overlayed. Additional coloring and/or shading may further help to visualize certain data. These may be accompanied by other visual signals like flashing and/or additional auditory information, e.g. to inform the crew about an emergency or similar.

Advantageous embodiments and improvements of the present invention are found in the subordinate claims.

According to an embodiment of the invention, a current view of the passenger cabin may be captured with the video surveillance system, wirelessly transmitted to the portable crew device and overlayed there and projected together with the visual cabin information.

Hence, not only visual indicators representing data on the current cabin situation may be projected on the portable crew device. Rather, a real live view of the present situation within the passenger cabin may be projected, e.g. a static view from one or several fixed positions and/or directions.

According to an embodiment of the invention, the current view of the passenger cabin may be a static view being independent of a current viewing direction and a current position associated with the portable crew device.

In this embodiment a static sight of the cabin is provided on the smart glasses from a fixed perspective, e.g., as delivered by one or several cameras. The crew can then access this view of the cabin from anywhere inside the aircraft, e.g., from within the flight crew compartment even when sitting on a flight attendant seat with the back to the passenger cabin.

According to an embodiment of the invention, the current view of the passenger cabin may be a dynamic view being adapted according to a current viewing direction associated with the portable crew device.

In this case, a dynamic projection is provided on the smart glasses dependent on the direction of the person wearing the smart glasses. The cabin attendant is than able to dynamically assess the current situation in the cabin by moving the head around and thereby change the perspective on the cabin interior much like in a virtual reality environment. In order to provide such an adaptable current view/perspective on the cabin interior, several adaptable cameras may be combined to provide extensive coverage of the cabin interior. In that vein, the cabin attendant may also be able to assess the situation from different directions and/or positions within the cabin.

According to an embodiment of the invention, the visual cabin information may be projected on the portable crew device as augmented reality images.

For example, the projected image on the smart glasses may be adapted according to the current viewing direction of the respective cabin attendant, e.g., while walking along the aisle of the passenger cabin. Here, information can be displayed onto the glasses while looking through the glasses to project the information to a specific location within the passenger cabin with certain data overlayed over the current image of the cabin, in particular the seat occupation status and the seat belt status.

According to an embodiment of the invention, the computer-based evaluation system may assess a passenger status within the passenger cabin based on the captured live video feed, the passenger status including information on whether passengers are seated or standing. A corresponding passenger status may be projected on the portable crew device as part of the visual cabin information.

Hence, additional information may be taken into account besides the seat occupation status and the seat belt status.

The invention will be explained in greater detail with reference to exemplary embodiments depicted in the drawings as appended.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. In the figures, like reference numerals denote like or functionally like components, unless indicated otherwise.

FIG. 1 schematically depicts a top view of a passenger cabin of an aircraft according to an embodiment of the invention.

FIG. 2 schematically depicts a flow diagram of a method for surveillance of the passenger cabin of FIG. 1 according to an embodiment of the invention.

### DETAILED DESCRIPTION OF THE PREFERRED EMBODIMENTS

Although specific embodiments are illustrated and described herein, it will be appreciated by those of ordinary skill in the art that a variety of alternate and/or equivalent implementations may be substituted for the specific embodiments shown and described without departing from the scope of the present invention. Generally, this application is intended to cover any adaptations or variations of the specific embodiments discussed herein.

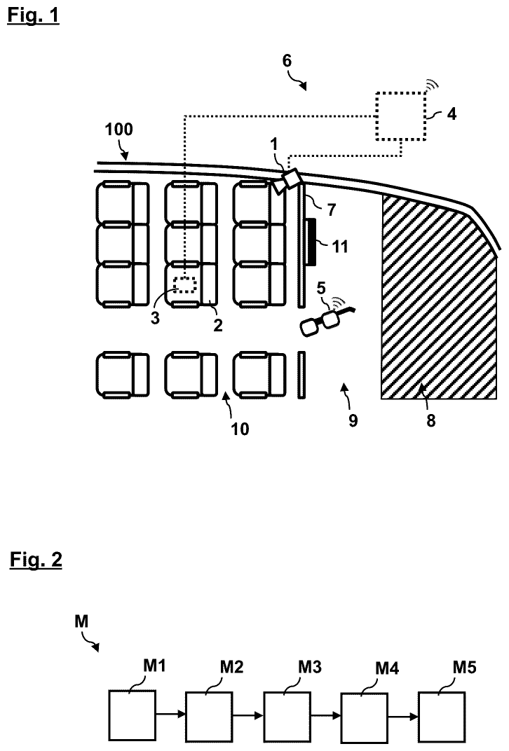

FIG. 1 schematically depicts a top view of a passenger cabin 10 of an aircraft 100 according to an embodiment of the invention that is provided with a cabin surveillance system 6. FIG. 2 schematically depicts a flow diagram of a method M for surveillance of the passenger cabin 10 of FIG. 1 according to an embodiment of the invention.

The aircraft 100 may be, for example, a single aisle passenger aircraft. FIG. 1 depicts a rear end of the respective aircraft 100. As can be seen in the figure, the aircraft 100 comprises a passenger cabin 10 with a plurality of passenger seats 2 and a flight crew compartment 9 with a flight attendant seat 11. Both cabin sections 10, 9 are separated by several partition walls 7, whereby a passageway is formed along the aisle that connects the flight crew compartment 9 with the passenger cabin 10 in the usual manner. The flight crew compartment 9 may include a galley 8 for example. It is to be understood that the depicted arrangement is merely an example. It will be clear to the person of skill that the invention can be used in various other cabin configurations. It is also clear that more than one flight attendant seat 11 could be provided within the flight crew compartment 9.

For passenger transportation, regulations usually require that at least a certain percentage of the passenger seats 2 must be visible by cabin attendants, in particular under critical phases of a flight like take-off and landing phases. The cabin attendants have to remain at respective flight attendant seats 11 (as the one exemplary shown in the figures) while being capable of monitoring the passenger seats 2 in accordance with the above-cited regulation requirements.

At the depicted rear end of the aircraft 100, the cabin attendants are conventionally seated against flight direction for better space usage in the rear end of the aircraft 100, as the galley 8 is arranged at the opposite end. As it is difficult or at least inconvenient for the cabin attendants to monitor the passenger cabin 10 from such a position, a monitoring system is typically installed within a cabin including a monitor mounted at the galley, which displays a live view of the passenger seats 2. These systems are typically rather complex and expensive, as the electrical installation needs to be provided between one or several cameras in the passenger cabin 10 and the monitor in the galley 8. In addition, the necessary mechanical provisions further increase the costs and weight of such conventional installations.

The present solution offers a simple alternative to such complex arrangements by relying on a digitized cabin environment with wireless access to sensor data and computer based systems that can be used to feed a live view of the cabin along with all relevant information to portable devices of the cabin attendants.

More specifically, the present cabin surveillance system 6 comprises a video surveillance system 1 configured to capture a live video feed of the passenger cabin 10, which may comprise one or several cameras installed within the passenger cabin 10, e.g., on the partition walls 7 between the passenger cabin 10 and the flight crew compartment 9. It is to be understood that this merely an example, as it will be clear to the person of skill that also other sensor technologies may be employed in addition for the present purpose.

The cabin surveillance system 6 further comprises a seat belt sensor system 3 configured to collect seat belt condition data of passenger seats 2 within the passenger cabin 10. The seat belt sensor system 3 may comprise, for example, wired contact switches within each individual seat belt as well as near field communication technology.

The cabin surveillance system 6 further comprises a computer-based evaluation system 4, which may be integrated in or communicatively coupled to a cabin management system of the aircraft (e.g. via a wireless data network). The computer-based evaluation system 4 is configured to assess a current seat occupation status of the passenger seats 2 based on the captured live video feed and a current seat belt status of the passenger seats 2 based on the collected seat belt condition data.

For example, the system 4 may distinguish between empty and occupied seats based on machine learning and/or artificial intelligence tools. In another example, the system 4 may be able to detect whether passengers are seated or standing. To this end, the computer-based evaluation system 4 may additionally assess a passenger status within the passenger cabin 10 based on the captured live video feed, wherein the passenger status includes information on whether passengers are seated or standing. The system 4 may even be used to automatically identify the passengers based on booking and identification information provided for each flight.

Hence, the system 4 is able to assess the current seat occupation as well as the seat belt situation, that is, whether the seat belts of occupied seats are fastened or not, as well as whether passenger are standing, e.g., in the aisle or are using the lavatory etc.

The respective data are then wirelessly transmitted by the computer system 4 to portable crew devices 5 of the aircraft crew, in particular to smart glasses of each crew member (one of which is exemplarily shown in FIG. 1).

Based on the received seat occupation status, the seat belt status and passenger status, each pair of smart glasses 5 then projects visual cabin information representing the seat occupation status and the seat belt status on the portable crew device 5. The visual cabin information may be overlayed over a current view of the passenger cabin 10 as captured with the cabin surveillance system 1 and projected together with it on the portable crew device 5. The visual cabin information may be particularly projected on the portable crew device 5 as augmented reality images.

The corresponding method M as schematically shown in FIG. 2 comprises under M1 capturing the live video feed of the passenger cabin 10 with the video surveillance system 1, under M2 collecting the seat belt condition data of the passenger seats 2 with the seat belt sensor system 3, under M3 assessing with the computer-based evaluation system 4 the current seat occupation status of the passenger seats 2 and the passenger status based on the captured live video feed and the current seat belt status of the passenger seats 2 based on the collected seat belt condition data.

The method M further comprises under M4 wirelessly transmitting the seat occupation status, the passenger status and the seat belt status to the smart glasses used as portable crew device 5. Under M5 the method M comprises projecting visual cabin information representing the seat occupation status and the seat belt status on the portable crew device 5, which may be projected together with a current view of the passenger cabin 10 as captured with the video surveillance system 1.

At least two different modes can be provided here: In one case, a static view can be displayed on the smart glasses 5, which is independent of a current viewing direction and a current position associated with the respective smart glasses 5. For example, a video feed of the full cabin 10 or of some segments/portions of it may be projected on the smart glasses. The cabin information may then be overlayed over this video feed in the form of visual indicators like icons, highlighted and/or colored elements, numbers etc. that may indicated whether passengers are standing or are sitting but have not fastened their seatbelts. Also a sight along the aisle may be possible via the glasses 5 (independent of the attendant's current position).

In an alternative mode, the current view of the passenger cabin 10 may be a dynamic view being adapted according to the current viewing direction of the cabin attendant wearing the respective smart glasses 5.

The smart glasses 5 may be configured to display the visual cabin information together with the view of the passenger cabin 10 as augmented reality images. In principle, these information can also be displayed onto the glasses while looking through the glasses standing at a certain position within the cabin 10 and looking in a certain direction. In this case, (un-) occupied seats and/or (un-) fastened seatbelts may be highlighted within the view based on the ML/AI-supported evaluation and thus point the cabin attendants directly to the respective seats 2.

The present solution thus makes use of a digitized cabin environment to provide the cabin attendants with improved means to monitor the passenger cabin 10, thereby enhancing not only flexibility and efficiency but also safety, as they are able to access and evaluate a current situation within the cabin from basically anywhere in the aircraft.

The systems and devices described herein may include a controller or a computing device comprising a processing and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

In the foregoing detailed description, various features are grouped together in one or more examples or examples with the purpose of streamlining the disclosure. It is to be understood that the above description is intended to be illustrative, and not restrictive. It is intended to cover all alternatives, modifications and equivalents. Many other examples will be apparent to one skilled in the art upon reviewing the above specification. The embodiments were chosen and described in order to best explain the principles of the invention and its practical applications, to thereby enable others skilled in the art to best utilize the invention and various embodiments with various modifications as are suited to the particular use contemplated.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

1 video surveillance system
2 passenger seat
3 seat belt sensor system
4 computer-based evaluation system
5 portable crew device
6 cabin surveillance system
7 partition wall
8 galley
9 flight crew compartment
10 passenger cabin
11 flight attendant seat
100 aircraft
M method
M1-M5 method steps

1. A method for surveillance of a passenger cabin of an aircraft, the method comprising:
capturing a live video feed of the passenger cabin with a video surveillance system;
collecting seat belt condition data of passenger seats within the passenger cabin with a seat belt sensor system;
assessing with a computer-based evaluation system a current seat occupation status of the passenger seats based on the live video feed and a current seat belt status of the passenger seats based on the seat belt condition data;
wirelessly transmitting the seat occupation status and the seat belt status to a portable crew device, the portable crew device being a pair of smart glasses; and
projecting visual cabin information representing the seat occupation status and the seat belt status on the portable crew device.

2. The method according to claim 1, wherein a current view of the passenger cabin is captured with the video surveillance system, wirelessly transmitted to the portable crew device and overlayed and projected together with the visual cabin information on the portable crew device.

3. The method according to claim 2, wherein the current view of the passenger cabin is a static view being independent of a current viewing direction and a current position associated with the portable crew device.

4. The method according to claim 2, wherein the current view of the passenger cabin is a dynamic view being adapted according to a current viewing direction associated with the portable crew device.

5. The method according to claim 1, wherein the visual cabin information is projected on the portable crew device as augmented reality images.

6. The method according to claim 1, wherein the computer-based evaluation system assesses a passenger status within the passenger cabin based on the captured live video feed, the passenger status including information on whether a passenger is seated or standing, wherein a corresponding passenger status is projected on the portable crew device as part of the visual cabin information.

7. An aircraft comprising:
a passenger cabin comprising
a plurality of passenger seats, and
a cabin surveillance system, the cabin surveillance system comprising:
a video surveillance system configured to capture a live video feed of the passenger cabin;
a seat belt sensor system configured to collect seat belt condition data of passenger seats within the passenger cabin;
a computer-based evaluation system configured to assess a current seat occupation status of the passenger seats based on the live video feed and a current seat belt status of the passenger seats based on the seat belt condition data and to wirelessly transmit the seat occupation status and the seat belt status; and
a portable crew device, the portable crew device being a pair of smart glasses and being configured to receive the seat occupation status and the seat belt status from the computer-based evaluation system and to project visual cabin information representing the seat occupation status and the seat belt status on the portable crew device.

8. The aircraft according to claim 7, wherein the video surveillance system is configured to capture and wirelessly transmit a current view of the passenger cabin, wherein the portable crew device is configured to receive the current view and overlay and project the current view together with the visual cabin information on the portable crew device.

9. The aircraft according to claim 8, wherein the current view of the passenger cabin is a static view being independent of a current viewing direction and a current position associated with the portable crew device.

10. The aircraft according to claim 8, wherein the current view of the passenger cabin is a dynamic view being adapted according to a current viewing direction associated with the portable crew device.

11. The aircraft according to claim 7, wherein the portable crew device is configured to project the visual cabin information on the portable crew device as augmented reality images.

12. The aircraft according to claim 7, wherein the computer-based evaluation system is further configured to assess a passenger status within the passenger cabin based on the captured live video feed, the passenger status including information on whether a passenger is seated or standing, wherein the portable crew device is further configured to project a corresponding passenger status on the portable crew device as part of the visual cabin information.
